(19) United States
(12) Patent Application Publication
(10) Pub. No.: US 2009/0214255 A1
(43) Pub. Date: Aug. 27, 2009

(54) IMAGING CARTRIDGE AND IMAGE FORMING APPARATUS

(75) Inventors: Isamu Kugimiya, Toyokawa-shi (JP); Hiroshi Mizuno, Aisai-shi (JP); Naoto Yoshida, Toyokawa-shi (JP); Nozomu Kondo, Toyokawa-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/241,891

(22) Filed: Sep. 30, 2008

(30) Foreign Application Priority Data
Feb. 22, 2008 (JP) 2008-041417

(51) Int. Cl. G03G 21/16

(52) U.S. Cl. 399/111

(57) ABSTRACT

The present invention provides an imaging cartridge in which a handle, which is used for mounting the imaging cartridge to either one of two image forming apparatuses in which the attachment/detachment directions of the imaging cartridge are different, does not obstruct the mounting operation of the imaging cartridge to the other image forming apparatus. The imaging cartridge can be attached to or detached from a main body of a first image forming apparatus in a first direction, while can be attached to or detached from a main body of a second image forming apparatus in a second direction that is different from the first direction by 90 degrees. The imaging cartridge includes a pair of handles gripped upon attaching or detaching the imaging cartridge to or from the main body of the first image forming apparatus in the first direction. The handle of the pair of handles, which is positioned at the far side when the imaging cartridge is attached to or detached from the main body of the second image forming apparatus, is made of a movable handle that moves so as not to hinder the attaching or detaching operation.

This application is based on application No. 2008-41417 filed in Japan on Feb. 22, 2008, the contents of which are hereby incorporated by reference.

### BACKGROUND OF THE INVENTION

1. Field of the Invention

The present invention relates to an imaging cartridge for a copier, facsimile, printer, multifunction peripheral, or the like, and an image forming apparatus provided with the same.

2. Description of the Related Arts

As information apparatuses, there have conventionally been a printer that is a monofunction product that is connected to a personal computer or the like for only printing data, and a multifunction peripheral (MFP) that is a multi-functional product capable of scanning a document and copying a document in addition to the printing function. A printer-based MFP has recently been put on the market as a product that can handle A4-size sheet. In this type of the MFP, the sheet feeding direction (the sheet feeding direction from a sheet feed cassette or a manual sheet feed device) is the front-to-rear direction with respect to the front face of the apparatus. This is achieved under the consideration in which the exchange of an imaging cartridge that is consumable goods, replenishment of printing sheet, and jamming process can be performed only by an access from the front face, like the printer. Therefore, this configuration provides advantages such that the operability is excellent, the printer that is the base is less changed, and the imaging cartridge can be shared between the printer and the MFP.

However, considering that the MPF is provided with an option device such as a finisher or the like, a user can easily operate the MPF under the condition that the sheet feeding direction is set to the side-to-side direction with respect to the front face of the apparatus. With this configuration, the front face of the base printer is located at the right side (or left side) at the MFP, so that the replenishment of sheets or exchange of an imaging cartridge should be performed from the right side of the apparatus, which deteriorates the operability. Accordingly, it is required that the replenishment of sheets or exchange of an imaging cartridge is performed from the front face of the MFP, i.e., from the left side of the base printer, which needs a large-scale change in the structure of the main body of the apparatus or the imaging cartridge.

Japanese Unexamined Patent Application No. 2005-4178 discloses a process cartridge (synonymous with the imaging cartridge in the present specification) having a grip portion that is gripped when it is mounted to a first image forming apparatus and a mounting section to which a grip member is mounted, the grip member being gripped when it is mounted to a second image forming apparatus into which a process cartridge is inserted from the direction different from the direction in the case of the first image forming apparatus. However, in this process cartridge, the grip member should be added when it is used for the second image forming apparatus after it is used for the first image forming apparatus. Therefore, the management of the component and mounting manner are troublesome.

### SUMMARY OF THE INVENTION

The present invention aims to provide an imaging cartridge in which a handle, which is used for mounting the imaging cartridge to either one of two image forming apparatuses in which the attachment/detachment directions of the imaging cartridge to the respective image forming apparatuses are different, does not obstruct the mounting operation of the imaging cartridge to the other image forming apparatus, and to provide an image forming apparatus provided with the imaging cartridge.

Another object of the present invention is to provide an imaging cartridge that can be attached and detached within a minimum required space, even if the imaging cartridge is mounted to either one of two image forming apparatuses in which the attachment/detachment directions of the imaging cartridge to the respective image forming apparatuses are different, and to provide an image forming apparatus provided with the imaging cartridge.

In order to solve the above problem, according to the present invention, an imaging cartridge that can be attached to or detached from a main body of an image forming apparatus, and that has components required for an image formation and a casing, the cartridge being capable of being attached to or detached from a main body of a first image forming apparatus in a first direction, and being capable of being attached to or detached from a main body of a second image forming apparatus in a second direction that is different from the first direction by 90 degrees, and the cartridge including a pair of handles that are gripped when the imaging cartridge is attached to or detached from the main body of the first image forming apparatus in the first direction, wherein the handle of the pair of handles positioned at the far side when the imaging cartridge is attached to or detached from the main body of the second image forming apparatus in the second direction is made of a movable handle that moves in order not to hinder the attaching or detaching operation.

The term “imaging unit” here means a unit required for an image formation, such as a photoreceptor, developing roller, or the like. The term “imaging cartridge” here means the one having an imaging unit and detachably mounted to a main body of an image forming apparatus.

In the imaging cartridge having the aforesaid configuration, the handle composed of a movable handle that is gripped when the imaging cartridge is attached to or detached from the main body of the first image forming apparatus in the first direction is movable when the imaging cartridge is attached to or detached from the main body of the second image forming apparatus in the second direction. Therefore, the handle does not hinder the attaching or detaching operation. Further, it is unnecessary to increase the opening portion of the second image forming apparatus in order to insert or draw the handle when the imaging cartridge is attached to or detached from the main body of the second image forming apparatus in the second direction, whereby the attaching or detaching operation can be performed within a minimum required space.

The movable handle is mounted so as to be slidable on a guide rail formed to be parallel to the second direction of the casing, and when the imaging cartridge is attached to the main body of the second image forming apparatus in the second direction, the movable handle is brought into contact with an edge portion of an opening portion at the main body and remains at the edge portion, by which only the casing is inserted into the main body.

In this case, the movable handle is brought into contact with the handle at the opposite side when the imaging cartridge is attached to the main body of the second image forming apparatus in the second direction. Also, the movable handle has a pivot portion at its leading end, wherein when the imaging cartridge is attached to the main body of the second image forming apparatus in the second direction, the pivot portion of the movable handle abuts against the main body to be folded.

The movable handle includes a positioning projection that is engaged with a hole formed on the second image forming apparatus, and an engagement hole with which a latch formed on the second image forming apparatus is engaged, when the imaging cartridge is attached to the main body of the second image forming apparatus in the second direction.

With this configuration, the movable handle can be stabilized when the imaging cartridge is attached to or detached from the main body of the second image forming apparatus in the second direction, whereby the attaching or detaching operation can be facilitated. When the imaging cartridge is removed from the second image forming apparatus, the movable member is returned to the original position. Therefore, a user does not have to manually return the movable member.

The movable handle is pivotably mounted to the casing, and when the imaging cartridge is attached to the main body of the second image forming apparatus in the second direction, the movable handle pivots through the abutment against the main body of the second image forming apparatus, by which the movable handle is engaged with the guide rail mounted to the main body so as to slide thereon.

In the imaging cartridge having the aforesaid configuration, the movable handle serves as a guide member that is slidably engaged with a guide rail of the main body of the second image forming apparatus. Therefore, it is unnecessary to provide another guide member separately, thereby simplifying the configuration.

The movable handle is slidably provided so as to project from the casing or so as to approach the casing, and when the imaging cartridge is attached to the main body of the first image forming apparatus in the first direction, the movable handle is pressed by the main body of the second image forming apparatus, and slides along a guide receiving portion formed on the main body to be inserted into the main body.

In the imaging cartridge having the aforesaid configuration, when the imaging cartridge is attached to or detached from the main body of the first image forming apparatus in the first direction, the movable member serving as the handle upon attaching or detaching the imaging cartridge to or from the main body of the first image forming apparatus in the first direction is withdrawn into the main body. Therefore, it is unnecessary to increase the opening portion of the first image forming apparatus in order to insert or draw the handle when the imaging cartridge is attached to or detached from the main body of the first image forming apparatus in the first direction, whereby the attaching or detaching operation can be performed within a minimum required space.

The imaging cartridge is made by integrally forming at least two or more of a photosensitive unit including a photoreceptor and a charging device, a developing unit at least including a developing roller and a developing device, a toner hopper that accommodates new toner, and a waste toner bottle that accommodates waste toner.

According to the present invention, the handle composed of the movable handle gripped when the imaging cartridge is attached to or detached from the main body of the first image forming apparatus in the first direction is movable when the imaging cartridge is attached to or detached from the main body of the second image forming apparatus in the second direction. Therefore, the handle does not hinder the attaching or detaching operation. Further, it is unnecessary to increase the opening portion of the second image forming apparatus in order to insert or draw the handle, whereby the attaching or detaching operation can be performed within a minimum required space.

### BRIEF DESCRIPTION OF THE DRAWINGS

Further objects and advantages of the present invention will become clear from the following description taken in conjunction with the preferred embodiments thereof with reference to the accompanying drawings, in which:

FIG. 1 is a perspective view of an imaging cartridge according to a first embodiment of the present invention;

FIG. 2A is a plan view of the imaging cartridge shown in FIG. 1;

FIG. 2B is a sectional view taken along a line I-I in FIG. 2A;

FIG. 2C is a front view;

FIG. 3A is a perspective view of the first image forming apparatus;

FIG. 3B is a perspective view showing the state in which the imaging cartridge shown in FIG. 1 is being attached to the first image forming apparatus in the first direction;

FIG. 4 is a perspective view showing the state in which the imaging cartridge is attached to the first image forming apparatus in the first direction;

FIG. 5 is a sectional view showing the state in which the imaging cartridge is attached to the first image forming apparatus in the first direction;

FIG. 6A is a perspective view of a second image forming apparatus;

FIG. 6B is a perspective view showing the state in which the imaging cartridge is being attached to the second image forming apparatus in the second direction;

FIG. 7 is a perspective view showing the state in which the imaging cartridge is attached to the second image forming apparatus in the second direction;

FIG. 8 is a sectional view showing the state in which the imaging cartridge is attached to the second image forming apparatus in the second direction;

FIG. 9 is a perspective view of an imaging cartridge according to a second embodiment of the present invention;

FIG. 10 is a partially enlarged perspective view of FIG. 9;

FIG. 11 is a perspective view showing the state in which the imaging cartridge shown in FIG. 9 is being attached to the first image forming apparatus in the first direction;

FIG. 12 is a perspective view showing the state in which the imaging cartridge shown in FIG. 9 is being attached to the second image forming apparatus in the second direction;

FIG. 13 is a partially enlarged perspective view of the second image forming apparatus shown in FIG. 12;

FIG. 14 is a plan view sequentially showing the operation of a movable handle when the imaging cartridge shown in FIG. 9 is being attached to the second image forming apparatus in the second direction;

FIG. 15 is a perspective view of an imaging cartridge according to a third embodiment of the present invention;

FIG. 16A is a plan view of the imaging cartridge shown in FIG. 15;

FIG. 16B is a side view thereof;

FIG. 16C is a front view thereof;

FIG. 17 is a perspective view showing the state in which the imaging cartridge shown in FIG. 15 is being attached to the first image forming apparatus in the first direction;

FIG. 18 is a perspective view showing the state in which the imaging cartridge shown in FIG. 15 is attached to the first image forming apparatus in the first direction;

FIG. 19 is a sectional view showing the state in which the imaging cartridge shown in FIG. 15 is attached to the first image forming apparatus in the first direction;

FIG. 20 is a perspective view showing the state in which the imaging cartridge shown in FIG. 15 is being attached to the second image forming apparatus in the second direction;

FIG. 21 is a perspective view showing the state in which the imaging cartridge shown in FIG. 15 is attached to the second image forming apparatus in the second direction;

FIG. 22 is a sectional view showing the state in which the imaging cartridge shown in FIG. 15 is attached to the second image forming apparatus in the second direction;

FIG. 23 is a perspective view of an imaging cartridge according to a fourth embodiment of the present invention;

FIG. 24A is a plan view of the imaging cartridge shown in FIG. 23;

FIG. 24B is a side view thereof;

FIG. 25 is a perspective view showing the state in which the imaging cartridge shown in FIG. 23 is being attached to the first image forming apparatus in the first direction;

FIG. 26 is a partially enlarged view showing the state in which the imaging cartridge shown in FIG. 23 is attached to the first image forming apparatus in the first direction;

FIG. 27 is a sectional view showing the state in which the imaging cartridge shown in FIG. 23 is attached to the first image forming apparatus in the first direction;

FIG. 28 is a perspective view showing the state in which the imaging cartridge shown in FIG. 23 is being attached to the second image forming apparatus in the second direction;

FIG. 29 is a sectional view of a printer that is a more specific first image forming apparatus provided with the imaging unit according to the present invention;

FIG. 30 is a sectional view of a base printer of an MFP that is a more specific second image forming apparatus provided with the imaging unit according to the present invention;

FIG. 31 is a sectional view of another printer that is a more specific first image forming apparatus provided with the imaging unit according to the present invention; and

FIG. 32 is a sectional view of a base printer of another MFP that is a more specific second image forming apparatus provided with the imaging unit according to the present invention.

### DETAILED DESCRIPTION OF THE PREFERRED EMBODIMENTS

The present invention will be explained with reference to the appended drawings.

### First Embodiment

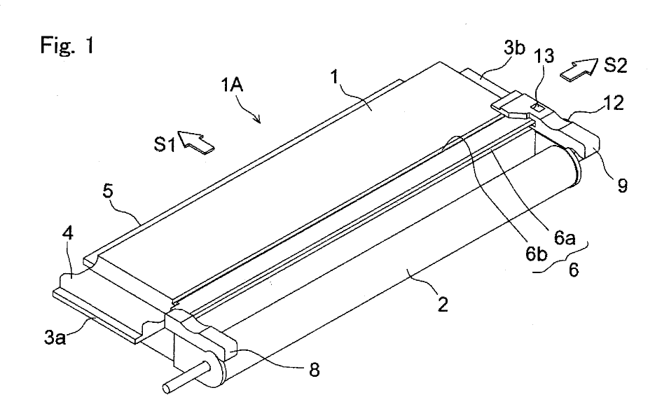

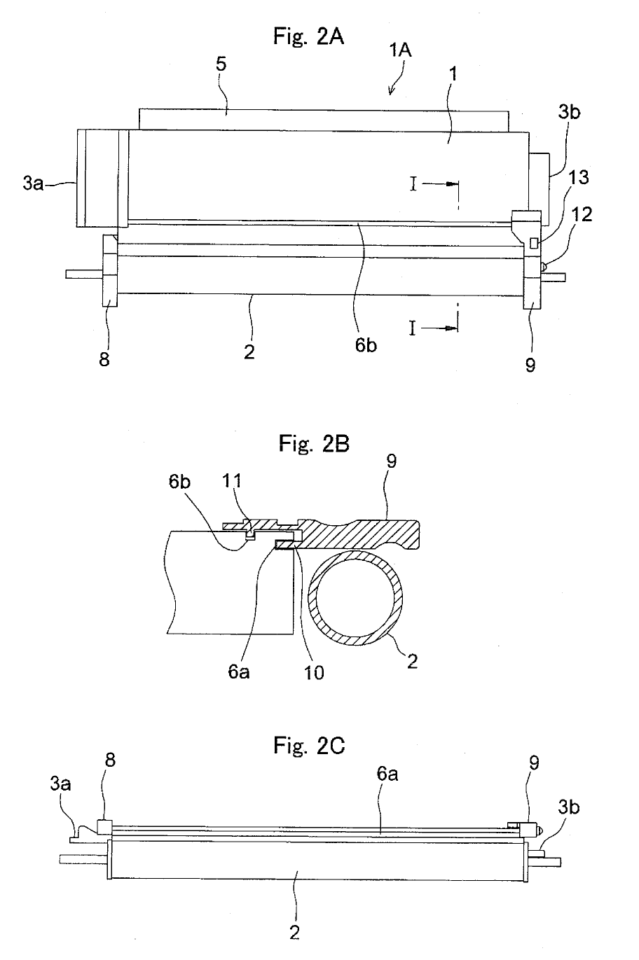

FIGS. 1 and 2 show an imaging cartridge 1A according to a first embodiment of the present invention. This imaging cartridge 1A is configured such that units required for an image formation are housed in a rectangular box-like casing 1, and one of the units required for the image formation is exposed at one end in the horizontal direction that is orthogonal to the longitudinal direction. The exposed unit is a photoreceptor 2 in the present embodiment and other embodiments described later, but the exposed unit may be a developing roller in the case of a developing cartridge, may be a cleaning blade in the case of a cleaning cartridge, or may be a toner transport roller or the like in the case of a new toner box or a waste toner box.

A first left guide 3a and a first right guide 3b are projectedly provided at both end faces of the imaging cartridge 1A in the longitudinal direction. The first left guide 3a and the first right guide 3b are formed into a rectangular plate, and extend in the direction orthogonal to the longitudinal direction of the imaging cartridge 1A. A grip portion 4 is provided to lift from the upper surface of the first left guide 3a.

A second guide 5 is projectedly provided at the end portion opposite to the photoreceptor 2 in the direction orthogonal to the longitudinal direction of the imaging cartridge 1A, and a guide rail 6 is formed at the upper surface of the end portion at the side of the photoreceptor 2. The second guide 5 is formed into a rectangular plate, and extends in the longitudinal direction of the imaging cartridge 1A. The guide rail 6 is made of a side-face groove 6a extending in the longitudinal direction at the end face of the imaging cartridge 1A and an upper-face groove 6b extending in the longitudinal direction of the imaging cartridge 1A at the upper surface.

A fixed handle 8 and a movable handle 9, which are used for inserting the imaging cartridge into a first image forming apparatus in a first inserting direction S1, are provided at both ends of the guide rail 6. The fixed handle 8 is provided at the near side of a second inserting direction S2 to a second image forming apparatus. The movable handle 9 is provided at the far side in the second inserting direction S2 to the second image forming apparatus. As shown in FIG. 2, the movable handle 9 has a horizontal projection 10 that is slidably engaged with the side-face groove 6a of the guide rail 6, and a vertical projection 11 that is slidably engaged with the upper-face groove 6b of the guide rail 6. These projections 10 and 11 are slidable in the longitudinal direction along the side-face groove 6a and the upper-face groove 6b of the guide rail 6. A positioning projecting portion 12 that is fitted to a hole 24 formed on the main body 15a of the later-described second image forming apparatus 15 is provided to the side face of the movable handle 9, while an engagement hole 13 with which a latch 25 mounted to the main body 15a of the second image forming apparatus is engaged is formed on the upper surface thereof.

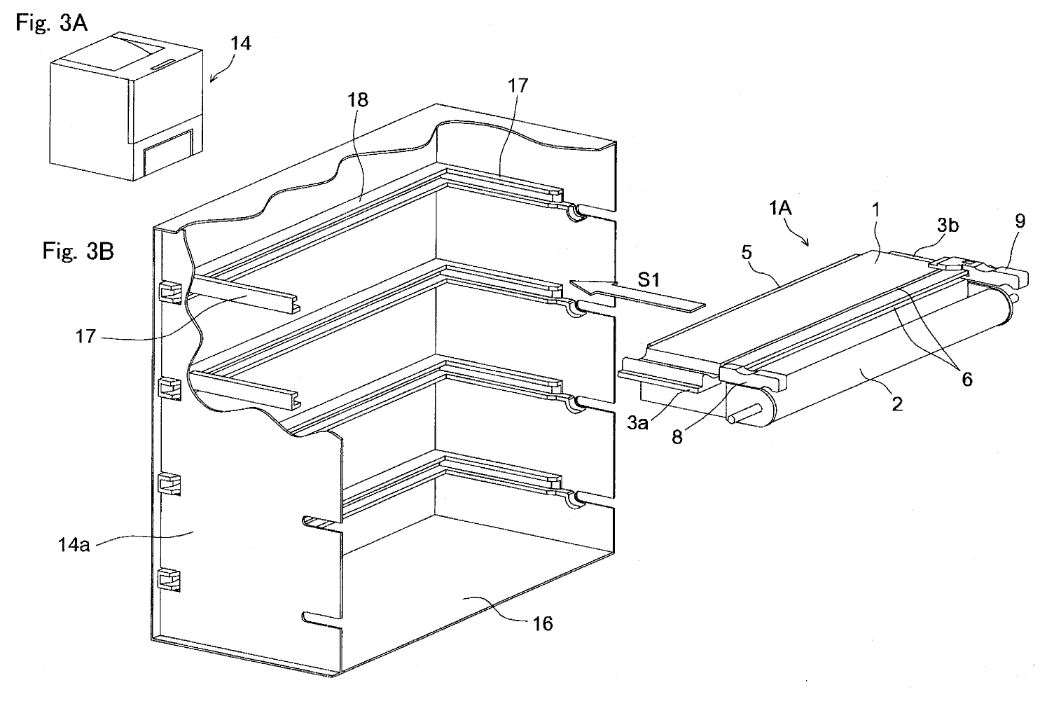

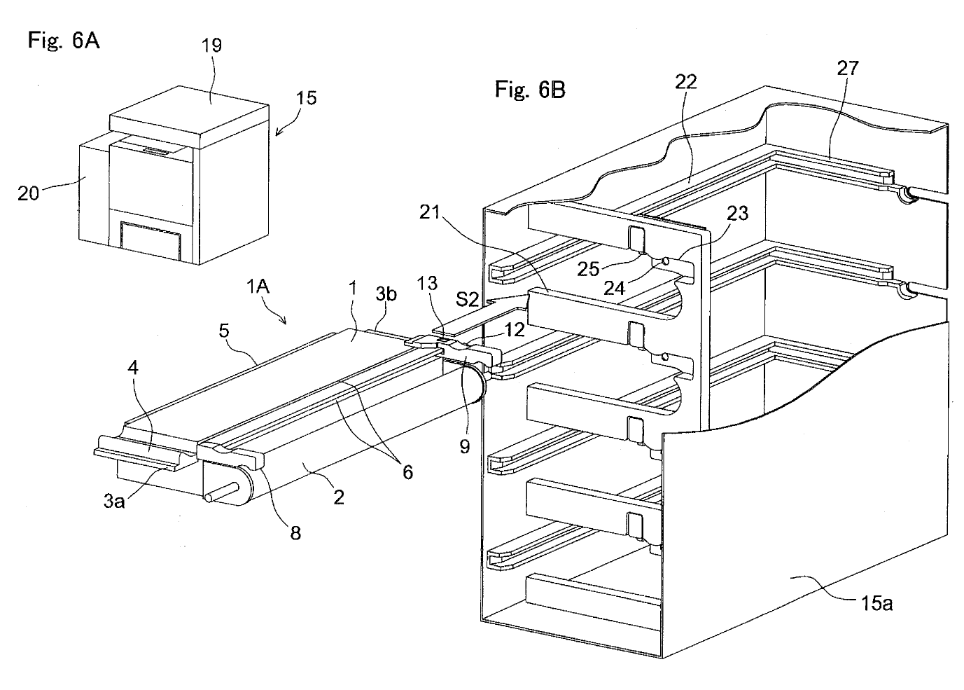

The imaging cartridge 1A thus configured can be attached to or detached from a main body 14a of the first image forming apparatus 14 and the main body 15a of the second image forming apparatus 15 as shown in FIGS. 3 and 6.

The first image forming apparatus 14 shown in FIG. 3 is a printer, wherein the right side in FIG. 3 is a front face. The printer has an opening portion 16 at the front face, and four imaging cartridges 1A can be attached to or detached from the opening portion 16 in the first direction S1 that is orthogonal to the longitudinal direction of the imaging unit 1A. The main body 14a of the first image forming apparatus 14 is provided with guide receiving portions 17, which have a reversed C shape in its section for supporting the first left and right guides 3a and 3b of the imaging cartridge 1A, are formed at the right and left walls of the opening portion 16 so as to extend in the first direction S1. Further, an engagement groove 18 that has a reversed C shape in its section and with which the second guide 5 of the imaging cartridge 1A is engaged is formed at the far wall of the opening portion 16 so as to continuous with the guide receiving portions 17.

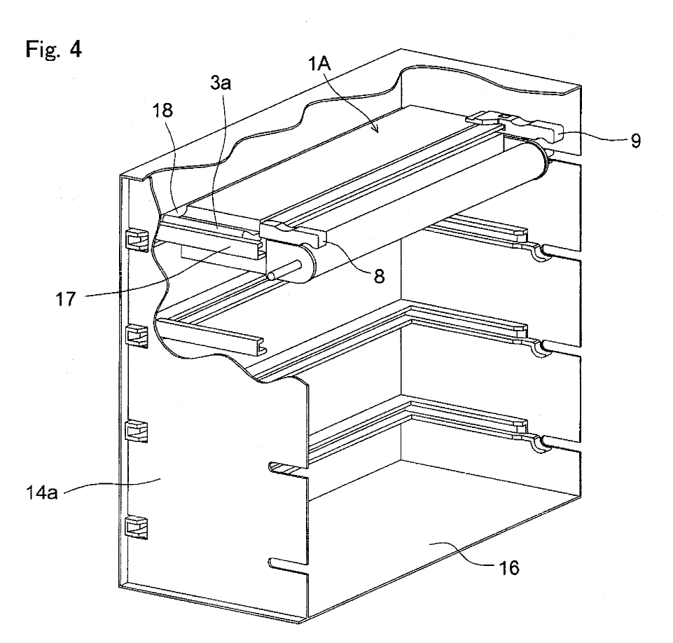

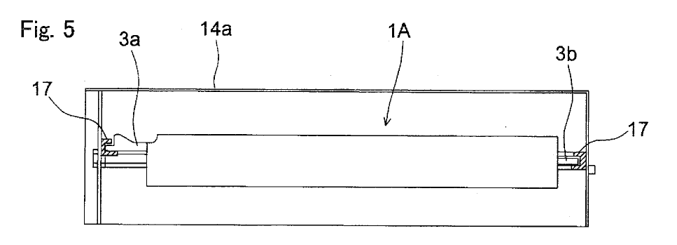

When the imaging cartridge 1A is inserted into the main body 14a of the first image forming apparatus 14 in the first direction S, the fixed handle 8 and the movable handle 9 are gripped to insert the first left and right guides 3a and 3b into the guide receiving portions 17. When the guides 3a and 3b are slid along the guide receiving portions 17, the first left and right guides 3a and 3b are supported by the guide receiving portions 17, and the second guide 5 is engaged with the engagement groove 18 as shown in FIGS. 4 and 5, whereby the imaging cartridge 1A is attached to the first image forming apparatus 14. On the other hand, when the imaging cartridge 1A is removed, a user may draw out the imaging cartridge 1A as gripping the fixed handle 8 and the movable handle 9.

The second image forming apparatus 15 shown in FIG. 6 is a base printer of an MFP to which a document reading device 19 or a sorter 20 is attached, wherein the front-left side in FIG. 6 is a front face. It has an opening portion 21 at its front face, and four imaging cartridges 1A can be attached to or detached from the opening portion 21 in the second direction S2, which is different from the first direction in FIG. 3 by 90 degrees, i.e., in the direction along the longitudinal direction of the photoreceptor 2.

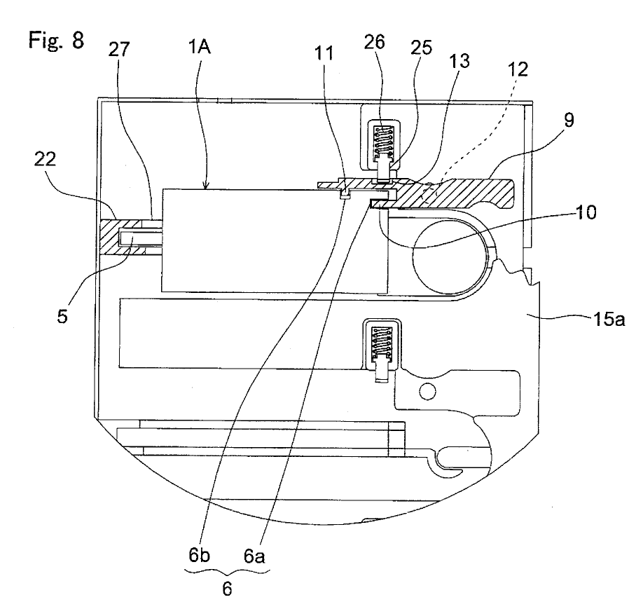

The main body 15a of the second image forming apparatus 15 is provided with a guide receiving portion 22, which has a reversed C shape in its section for supporting the second guide 5 of the imaging cartridge 1A, is formed at the left wall of the opening portion 21 so as to extend in the second direction S2. Formed at the right edge of the opening portion 21 is a concave portion 23 into which the leading end portion of the movable handle 9 at the imaging cartridge 1A is fitted, and a hole 24 into which the positioning projecting portion 12 of the movable handle 9 is fitted is formed at the bottom of the concave portion 23. A latch 25 that is engaged with the engagement hole 13 of the movable handle 9 is provided at the upper edge of the opening portion 21. The latch 25 is biased so as to downwardly project by means of a spring 26 as shown in FIG. 8. An engagement groove 27 that has a reversed C shape in its section and with which the first right guide 3b of the imaging cartridge 1A is engaged is formed at the far wall of the opening portion 21 so as to be continuous with the guide receiving portion 22.

The guide receiving portion 22 and the engagement groove 27 of the second image forming apparatus 15 are configured to have the shape same as that of the engagement groove 18 and the guide receiving portions 17 of the first image forming apparatus 11, so that they are shared.

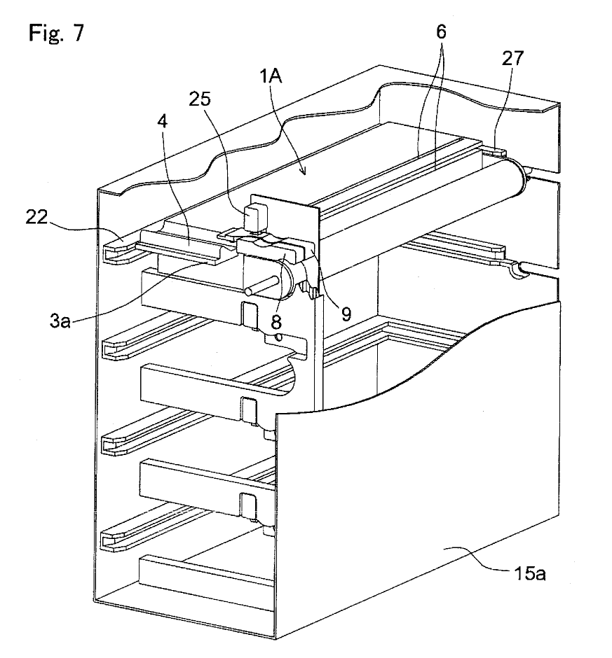

In order to insert the imaging cartridge 1A into the main body 15a of the second image forming apparatus 15 in the second direction S2, the first left guide 3a is gripped, the second guide 5 is inserted into the guide receiving portion 22, and the movable handle 9 is fitted into the concave portion 23 of the main body 15a. Thus, the positioning projecting portion 12 of the movable handle 9 is fitted into the hole 24 at the main body 15a, so that the latch 25 is engaged with the engagement hole 13 of the movable handle 9 as shown in FIG. 8. As a result, the movable handle 9 is supported by the edge portion of the opening portion 21 at the main body 15a. Therefore, even if the imaging cartridge 1A is forcibly pushed into the main body 15a, the movable handle 9 remains at the edge portion of the opening portion 21 at the main body 15a. The imaging cartridge 1A is inserted with the guide receiving portion 22 of the main body 15a and the movable handle 9 defined as a guide. When the sliding operation of the imaging cartridge 1A is completed, as shown in FIGS. 7 and 8, the second guide 5 is supported by the guide receiving portion 22, the fixed handle 8 is brought into contact with the movable handle 9, and the first right guide 3b is engaged with the engagement groove 27, whereby the imaging cartridge 1A is mounted to the second image forming apparatus 15. On the other hand, when the imaging cartridge 1A is removed, a user may grip the first left guide 3a to draw the imaging cartridge 1A. In this case, since the latch 25 is engaged with the engagement hole 13, the movable handle 9 remains at this position, and when the imaging cartridge 1A is removed, the engagement is canceled, so that the movable handle 9 is returned to the position before the insertion.

### Second Embodiment

The other embodiments of the present invention will be explained next. In the following explanation, like numerals refer to like parts, and the explanation thereof is omitted.

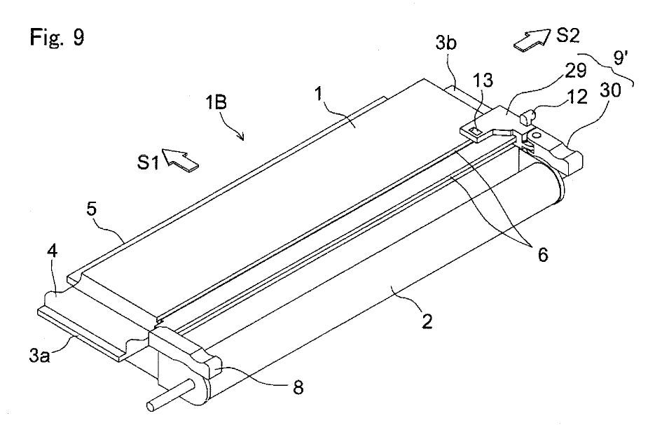

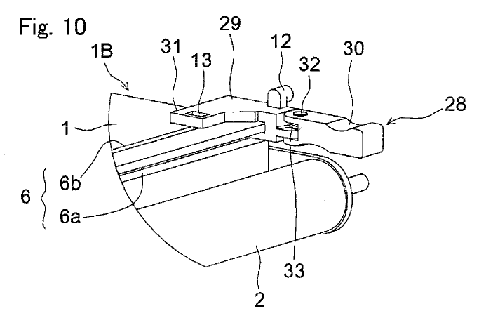

FIG. 9 shows an imaging cartridge 1B according to a second embodiment of the present invention. The imaging cartridge 1B is the same as the imaging cartridge 1A shown in FIG. 1 except that a movable handle 9′ is made of a fixed portion 29 and a pivot portion 30. As shown in FIG. 10, the fixed portion 29 of the movable handle 9′ has the positioning projecting portion 12 and the engagement hole 13. The positioning projecting portion 12 projects from the upper face of the fixed portion 29 in the longitudinal outward direction of the imaging cartridge 1B. The engagement hole 13 is formed on a projecting member 31 extending in the longitudinal inward direction from the upper face of the fixed portion 29. The movable portion 30 of the movable handle 9′ is pivotably attached to the fixed portion 29 by a pin 32, and biased by a spring 33 in order to stand still in the right-angled direction in the longitudinal direction.

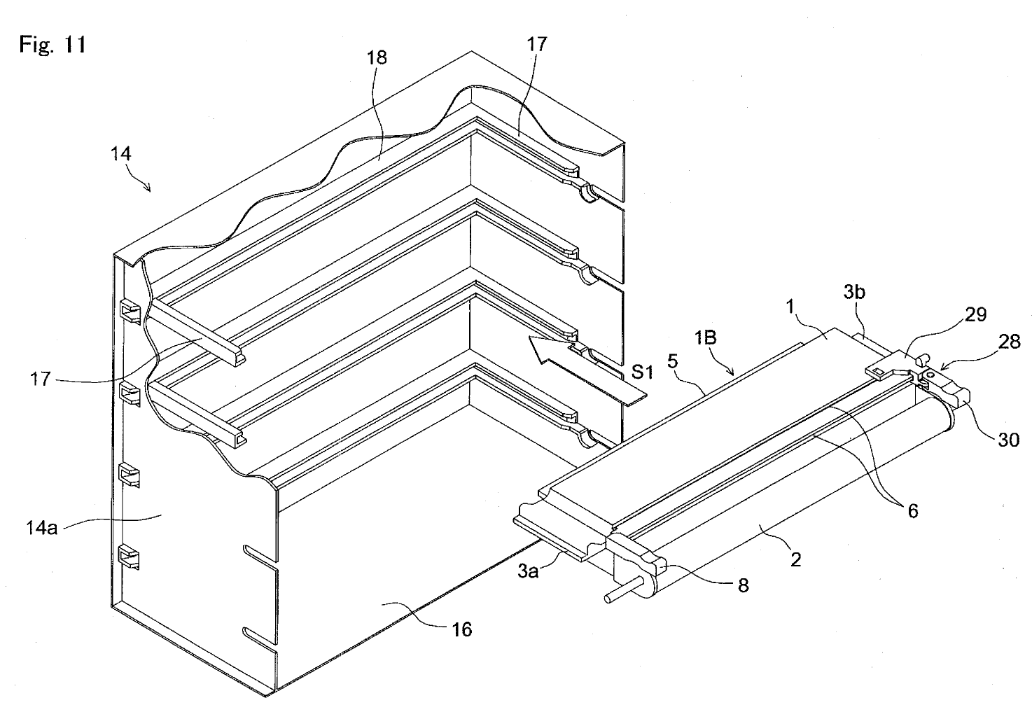

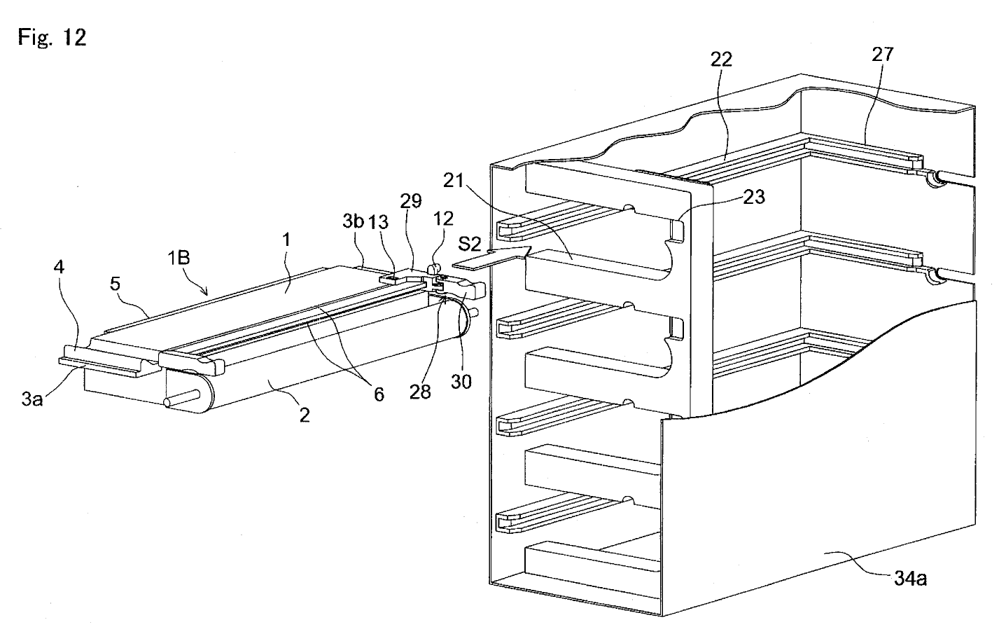

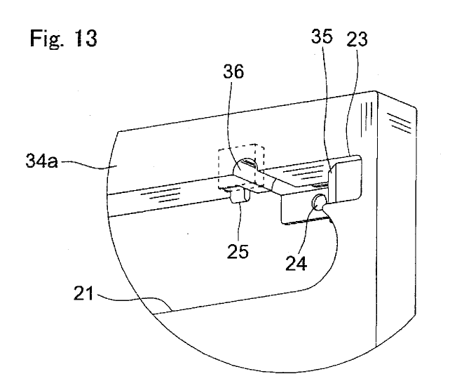

As shown in FIG. 11, the first image forming apparatus 14 to which the imaging cartridge 1B is attached is the same as that in the first embodiment. Further, as shown in FIGS. 12 and 13, the second image forming apparatus 34 has the latch 25 and the hole 24 at the edge portion of the opening portion 21, like the first embodiment, but the shape of the edge portion of the opening portion 21 is different from the first embodiment. Specifically, the concave portion 23 at the opening portion 21 is deeper than the concave portion 23 of the second image forming apparatus in the first embodiment. Formed at the right end of the edge portion of the opening portion 21 is a slope 35 that is in contact with the pivot portion 30 of the movable handle 9′ of the imaging cartridge 1B and guides the pivot portion 30 to pivot. A groove 36 through which the positioning projecting portion 12 of the movable handle 9′ passes is formed on the upper edge face of the opening portion 21.

The operation for attaching and detaching the imaging cartridge 1B to and from the main body 14a of the first image forming apparatus 14 is the same as that in the first embodiment as shown in FIG. 11, so that the explanation is omitted. The operation for attaching and detaching the imaging cartridge 1B to and from the second image forming apparatus 34 will be explained below.

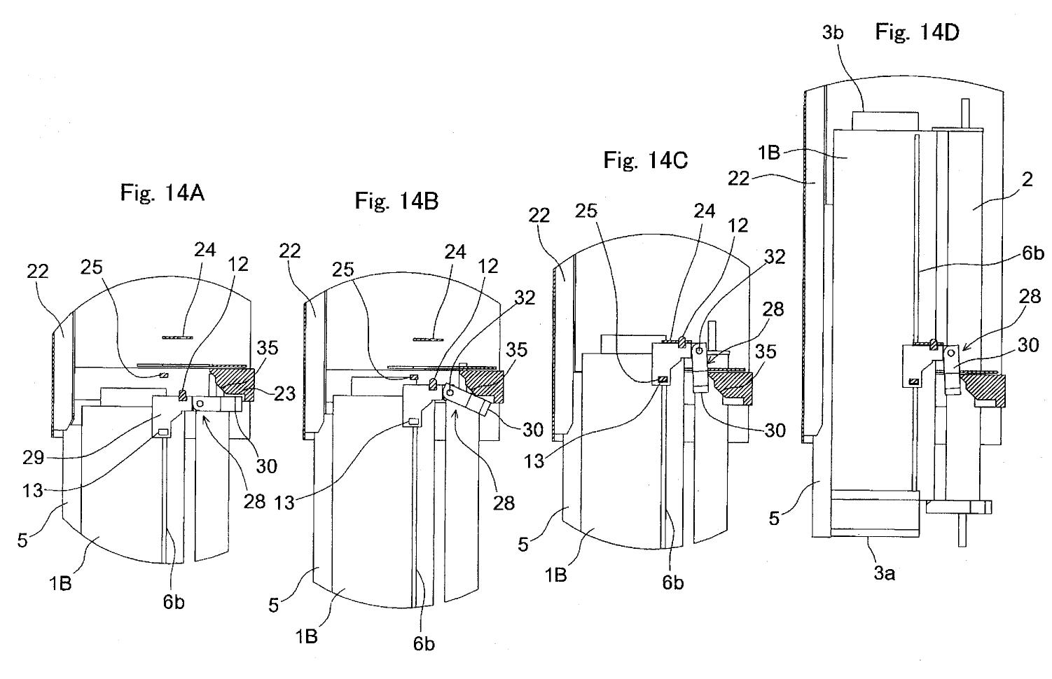

In order to insert the imaging cartridge 1B into the main body 34a of the second image forming apparatus 34, the first left guide 3a is gripped and the second guide 5 is inserted into the guide receiving portion 22 as shown in FIG. 12, and then, the movable handle 9′ is fitted into the concave portion 23 at the main body as shown in FIG. 14A. When the imaging cartridge 1B is pushed, the pivot portion 30 of the movable handle 9′ is brought into contact with the bottom of the concave portion 23 so as to pivot about the pin 32 against the biasing force of the spring 33, so that the pivot portion is folded as guided by the slope 35. Thus, the positioning projecting portion 12 of the movable handle 9′ is fitted into the hole 24 of the main body 34a, and the latch 25 is engaged with the engagement hole 13 of the movable handle 9′. As a result, since the movable handle 9′ is supported by the edge portion of the opening portion 21 of the main body 34a, the movable handle 9′ remains at the edge portion of the opening portion 21 of the main body 34a as shown in FIG. 14D, even if the imaging cartridge 1B is pushed into the main body 34a. The imaging cartridge 1B is inserted into the main body 34a with the guide receiving portion 22 and the movable handle 9′ as a guide. After the sliding operation of the imaging cartridge 1B is completed, the second guide 5 is supported by the guide receiving portion 22, the fixed handle 8 is brought into contact with the movable handle 9′, and the first right guide 3b is engaged with the engagement groove 27, whereby the imaging cartridge 1B is mounted. On the contrary, in order to remove the imaging cartridge 1B, a user may draw the imaging cartridge 1B by gripping the grip portion 4 of the first left guide 3a. The pivot portion 30 is returned to the original position due to the biasing force of the spring 33.

### Third Embodiment

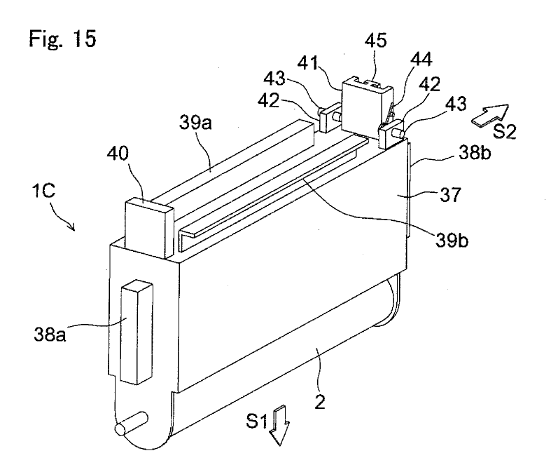

FIG. 15 shows an imaging cartridge 1C according to the third embodiment of the present invention. This imaging cartridge 1C is configured such that units required for an image formation are housed in a rectangular box-like casing 37, and a photoreceptor 2 is exposed at the lower end in the vertical direction that is orthogonal to the longitudinal direction.

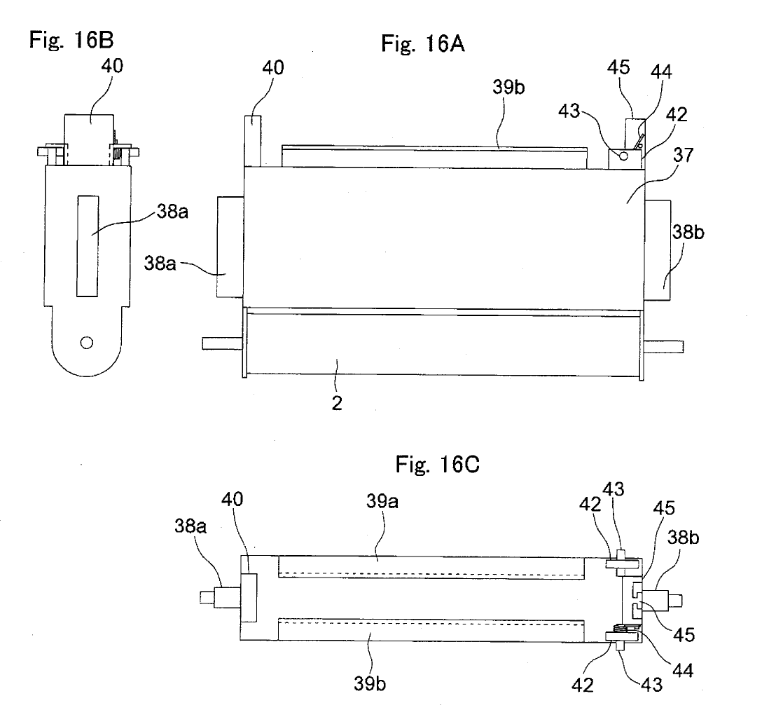

As shown in FIG. 16, a first left guide 38a and a first right guide 38b are projectedly provided at both end faces of the imaging cartridge LC in the longitudinal direction. The first left guide 38a and the first right guide 38b are formed into a rectangular plate-like shape, and extend in the vertical direction orthogonal to the longitudinal direction of the imaging cartridge 1C.

A second left guide 39a and a second right guide 39b are projectedly provided at the upper end face of the imaging cartridge 1C at the side opposite to the photoreceptor 2 in the direction orthogonal to the longitudinal direction of the imaging cartridge 1C. The second left guide 39a and the second right guide 39b are respectively formed to have a reversed L shape in their section, and extend in the longitudinal direction of the imaging cartridge 1C.

A fixed handle 40 and a movable handle 41, which are used for inserting the imaging cartridge 1C into the first image forming apparatus in the first inserting direction S1, are provided at both ends of the second left guide 39a and the second right guide 39b. The fixed handle 40 is provided at the near side in the second inserting direction S2 to the second image forming apparatus. The movable handle 41 is provided at the far side in the second inserting direction S2 to the second image forming apparatus. The movable handle 41 is mounted to a pair of projecting portions 42 so as to be pivotable through a pin 43, and biased by a spring 44 in order to stand still in the right-angled direction in the longitudinal direction. A third guide 45 whose section is formed into a T shape is formed at the side face of the movable handle 40.

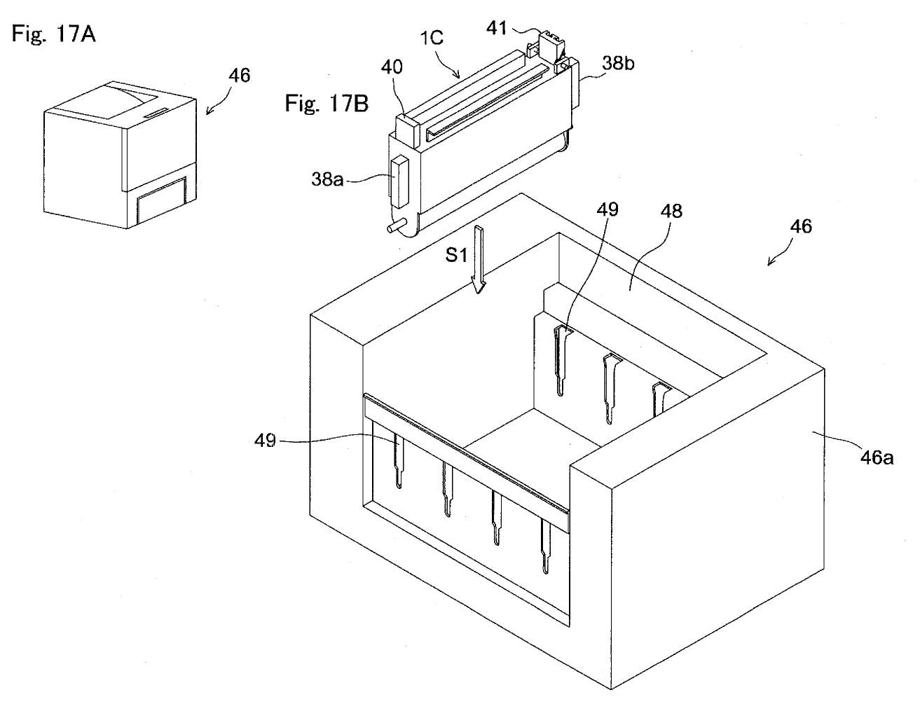

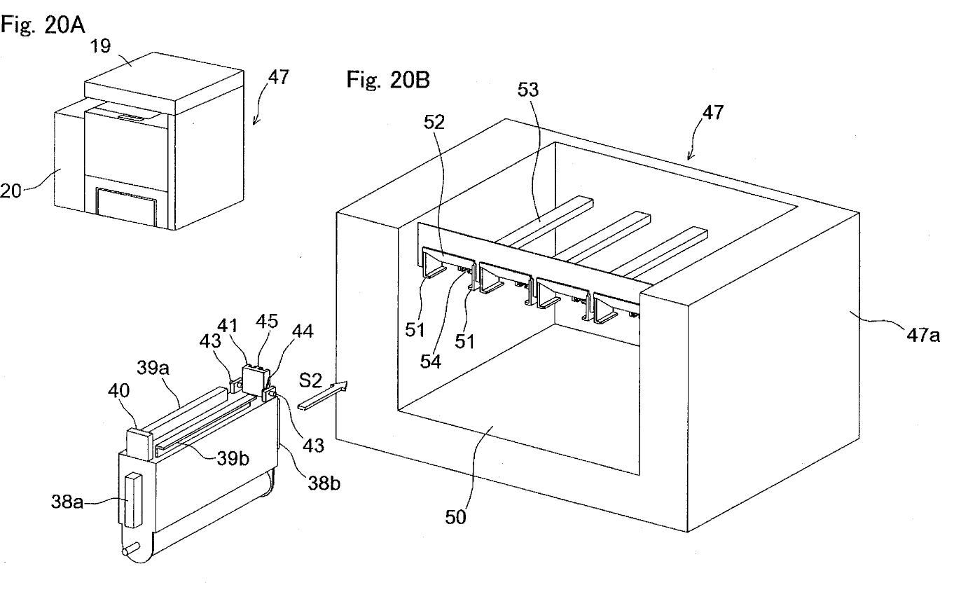

The imaging cartridge 1C thus configured can be attached to or detached from a main body 46a of a first image forming apparatus 46 and a main body 47a of a second image forming apparatus 47 as shown in FIGS. 17 and 20.

The first image forming apparatus 46 shown in FIG. 17 is a printer. The first image forming apparatus 46 has an opening portion 48 at its upper face, wherein four imaging cartridges 1C can be attached to or detached from the opening portion 48 in the first direction S1 that is orthogonal to the longitudinal direction of the imaging unit 1C. Grooves 49 that receive the first left and right guides 38a and 38b of the imaging cartridge 1C are formed to the main body 46a of the first image forming apparatus 46 so as to extend in the first direction S1.

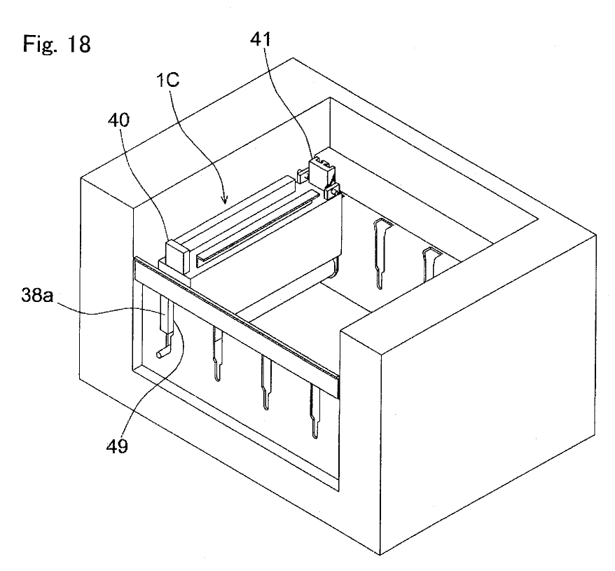

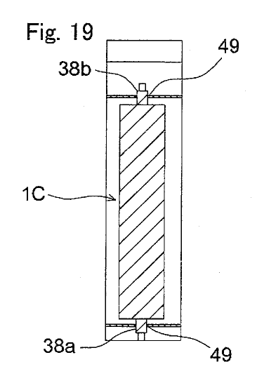

In order to insert the imaging cartridge 1C into the main body 46a of the first image forming apparatus 46 in the first direction S1, the fixed handle 40 and the movable handle 41 are gripped to insert the first left and right guides 38a and 38b into the grooves 49. When the guides 38a and 38b are slid along the grooves 49, the first left and right guides 38a and 38b are supported by the grooves 49, as shown in FIGS. 18 and 19, whereby the imaging cartridge 1C is attached to the first image forming apparatus 46. On the other hand, when the imaging cartridge 1C is removed, a user may draw out the imaging cartridge 1C as gripping the fixed handle 40 and the movable handle 41.

The second image forming apparatus 47 shown in FIG. 20 is a base printer of an MFP to which a document reading device 19 or a sorter 20 is attached. It has an opening portion 50 at its front face, and four imaging cartridges 1C can be attached to or detached from the opening portion 50 in the second direction S2, which is parallel to the longitudinal direction of the imaging unit 1C. A pair of guide receiving portions 51 that are engaged with the second left and right guides 39a and 39b of the imaging cartridge 1C are formed at the upper edge of the opening portion 50. A slope 52 that tilts downwardly from the upper edge of the opening portion 50 toward the far side is formed between the guide receiving portions 51. A horizontal guide bar 53 is mounted from the lower end of the slope 52 toward the wall at the far side. A groove 54 whose section is formed into a T shape and with which the third guide of the imaging cartridge 1C having the T-shaped section is engaged for slide is formed at the lower face of the guide bar 53.

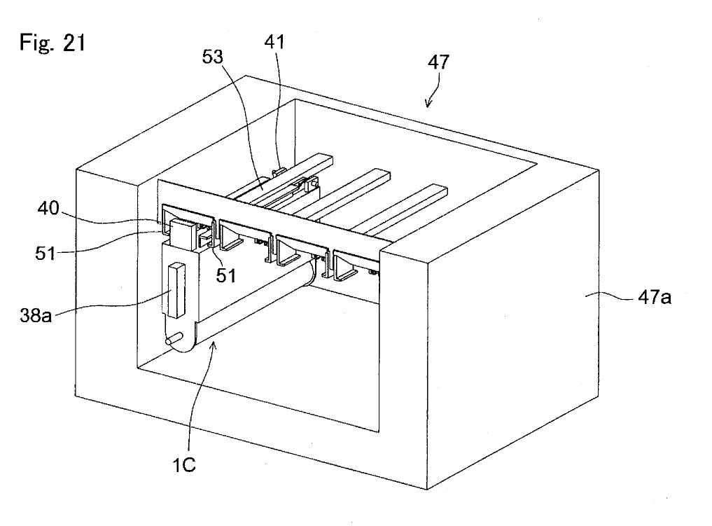

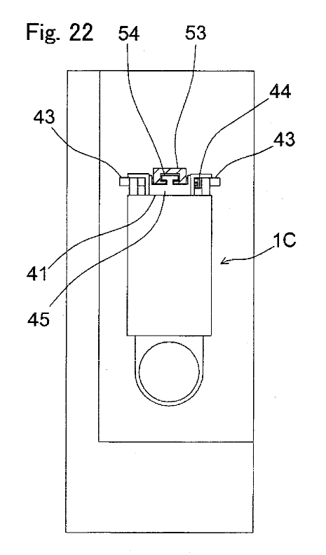

In order to attach the imaging cartridge 1C, the first left guide 38a and the fixed handle 40 are gripped with the movable handle 41 facing the opening portion 50, and the pin 43 of the movable handle 41 is placed onto the guide receiving portion 51 to push the imaging cartridge 1C. With this operation, the movable handle 41 is brought into contact with the slope 52, so that the movable handle 41 pivots about the pin 43 against the biasing force of the spring 44 so as to be folded as guided by the slope 52. Thus, the third guide 45 of the movable handle 41 is engaged with the groove 54 of the guide bar 53. As a result, when the imaging cartridge 1C is further pushed, the imaging cartridge 1C is inserted into the main body 47a with the third guide 45 of the movable handle 41 sliding along the groove 54 of the guide bar 53. The second left and right guides 39a and 39b are engaged with the guide receiving portions 51 to slide. After the sliding operation of the imaging cartridge 1C is completed, the second left and right guides 39a and 39b are supported by the guide receiving portions 51, and the third guide 45 of the movable handle 41 is engaged with the guide bar 53, whereby the imaging cartridge 1C is mounted as shown in FIGS. 21 and 22. On the other hand, in order to remove the imaging cartridge 1C, a user may draw the imaging cartridge 1C as gripping the first left guide 38a and the fixed handle 40. The movable handle 41 is returned to the original position due to the biasing force of the spring 44.

### Fourth Embodiment

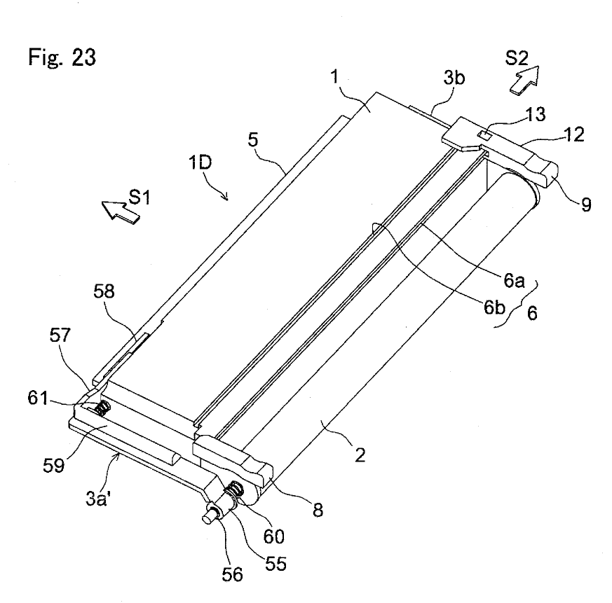

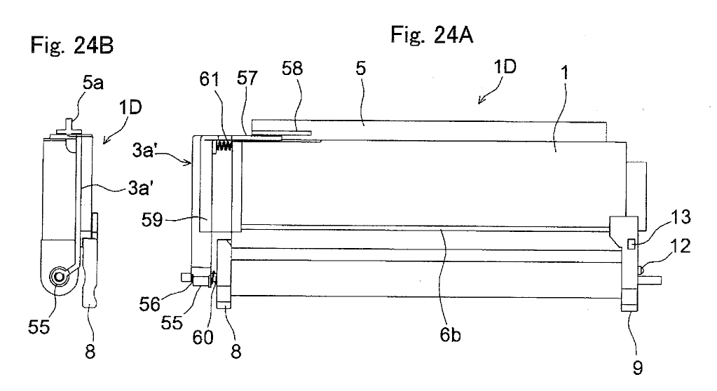

FIGS. 23 and 24 show an imaging cartridge 1D according to the fourth embodiment of the present invention. The imaging cartridge 1D is the same as the imaging cartridge 1A in the first embodiment except that the first left guide 3a′ is made movable. A tubular portion 55 is formed at one end of the first left guide 3a′. The tubular portion 55 is fitted into the shaft of the photoreceptor 2, and a stopper 56 prevents the tubular portion 55 from slipping out. An extended guide member 57 bent into an L shape is provided at the other end of the first left guide 3a′. This guide member 57 is inserted into a gap between a rib 58 provided at the upper face of the second guide 5 and the casing 1. A grip portion 59 is formed on the upper face of the first left guide 3a′ in order that a user easily puts his/her fingers thereon when the first left guide 3a′ is used as a handle. The first left guide 3a′ is biased in the direction apart from the casing 1 in the direction parallel to the second direction S2 by a spring 60 mounted to the shaft of the photoreceptor 2 between the tubular portion 55 and the casing 1 and a spring 61 mounted in the vicinity of the guide member 57 between the first left guide 3a′ and the casing 1.

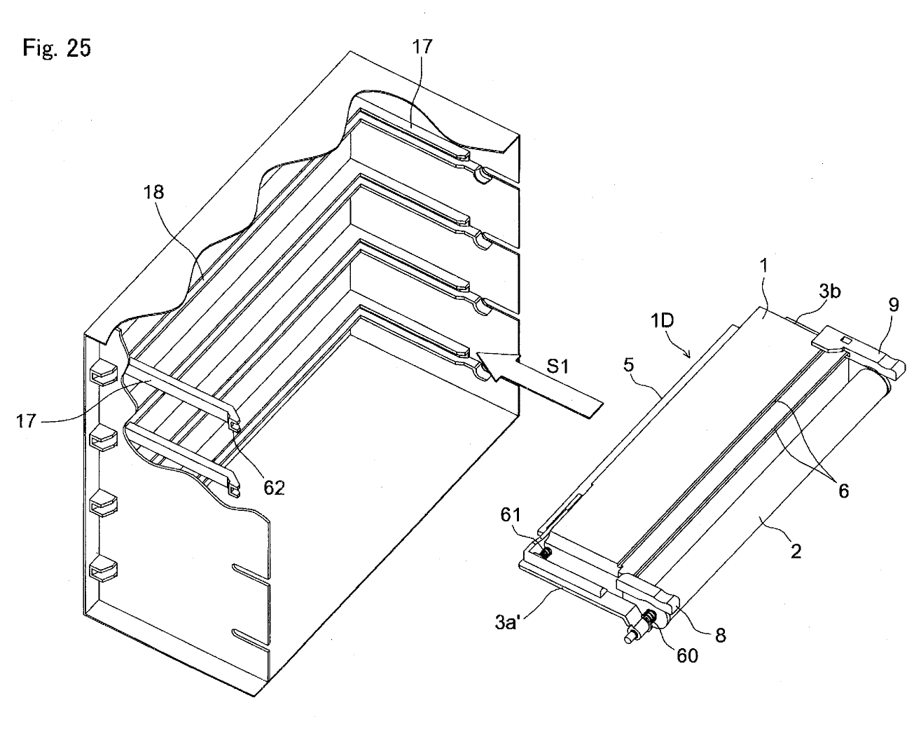

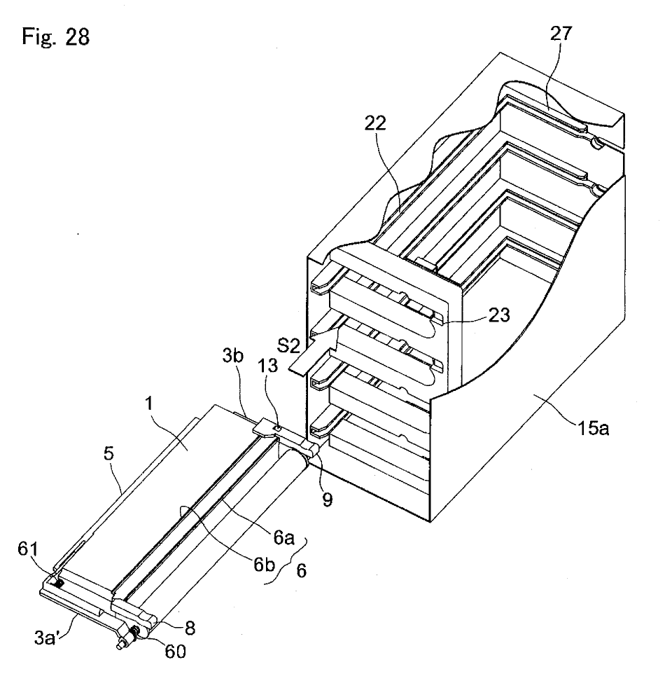

The imaging cartridge 1D thus configured can be attached to or detached from the main body 11a of the first image forming apparatus 11 and the main body 12a of the second image forming apparatus 12 as shown in FIGS. 25 and 28.

The first image forming apparatus 11 shown in FIG. 25 is the same as the first image forming apparatus 11 in the first embodiment except that a bent portion 62, which is bent outwardly, is provided at the inlet of the guide receiving portion 14 at the left side in order to readily accept the first left guide of the imaging cartridge 1D.

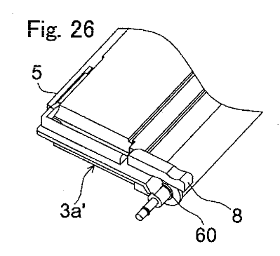

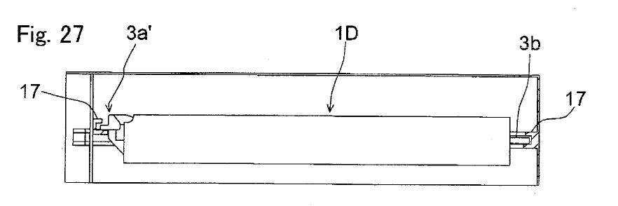

In order to insert the imaging cartridge 1D into the main body 11a of the first image forming apparatus 11 in the first direction S1, the fixed handle 8 and the movable handle 9 are gripped to insert the first left and right guides 3a′ and 3b into the guide receiving members 17. When the guides 3a′ and 3b are slid along the guide receiving members 17, the first left and right guides 3a′ and 3b are supported by the guide receiving members 17, and the second guide 5 is engaged with the engagement groove 18, whereby the imaging cartridge 1D is attached to the first image forming apparatus 11. As shown in FIGS. 26 and 27, the first left guide 3a′ retreats toward the end face of the casing 1 in the direction perpendicular to the inserting direction against the biasing force of the springs 60 and 61, as it is inserted into the guide receiving portion 17. On the other hand, when the imaging cartridge 1D is removed, a user may draw out the imaging cartridge 1D as gripping the fixed handle 8 and the movable handle 9. The first left guide 3a′ is returned to the original position due to the biasing force of the springs 60 and 61.

The second image forming apparatus shown in FIG. 28 is the same as the first image forming apparatus 15 in the first embodiment.

Like the case of the imaging cartridge 1A in the first embodiment, in order to insert the imaging cartridge 1D into the main body 15a of the second image forming apparatus 15 in the second direction S2, the first left guide 3a′ is gripped, the second guide 5 is inserted into the guide receiving portion 22, and the movable handle 9 is fitted into the concave portion 23 of the main body. Since the first left guide 3a′ is apart from the casing 1 of the imaging cartridge 1D by the springs 60 and 61, it is easily gripped as a handle. On the other hand, in order to remove the imaging cartridge 1D, a user may draw out the imaging cartridge 1D as gripping the first left guide 3a′.

### First Embodiment of First Image Forming Apparatus

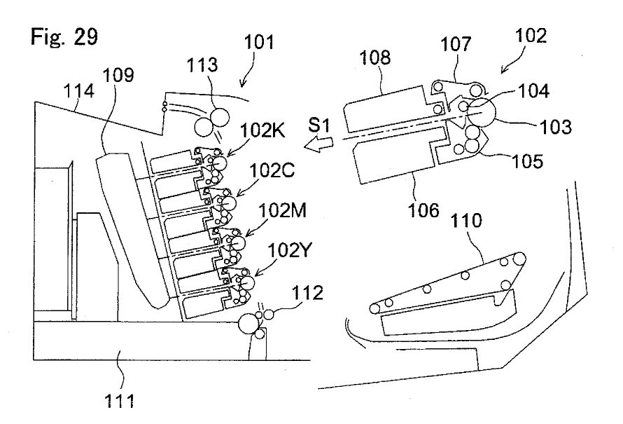

FIG. 29 shows a printer 101, which is a more specific first image forming apparatus provided with the imaging cartridge 102 according to the present invention. This printer 101 is a tandem-type color laser printer in which four imaging cartridges 102Y, 102M, 102C, and 102K of yellow, magenta, cyan, and black are arranged in the vertical direction. Each of the imaging cartridges 102 has any one of external structures (guide, handle, etc.) of the aforesaid imaging cartridges 1A, 1B and 1C, although not shown. Each of the imaging cartridges 102 is composed of a charging device 104 and a developing device 105, a new toner box 106, a cleaning device 107, and a waste toner box 108, which are arranged around a cylindrical photoreceptor 103 that is rotatably provided. In the imaging cartridge 102, the charging device 104 applies charges onto the photoreceptor 103, an electrostatic latent image is formed by an exposure device 109 on the basis of an image signal, and the electrostatic latent image is developed by the developing device 104. The developed toner image is transferred onto a sheet transported from a sheet feeding unit 111 between a transfer belt 110 and the photoreceptor 103 through a timing roller 112. The toner remaining onto the photoreceptor 103 after the transfer is collected into the waste toner box 108 by the cleaning device 107. The sheet having the toner image transferred thereon is conveyed to a fixing unit 113, where the toner image is fixed, and then, the sheet is discharged to a sheet tray 114.

The right side in FIG. 29 is the front face of the printer 101. This printer 101 is configured such that a sheet is supplied in the frontward direction from the sheet feeding unit 111, as viewed from the front face, conveyed in the vertical direction, and discharged in the rearward direction. The sheet feeding unit 111 can be attached or detached from the front face. When a door at the front face is opened, the transfer belt 110 is separated from the imaging cartridge 102 with the door. Accordingly, the imaging cartridge 102 can be attached or detached in the first direction S1 (in the side-to-side direction in the figure).

### First Embodiment of Second Image Forming Apparatus

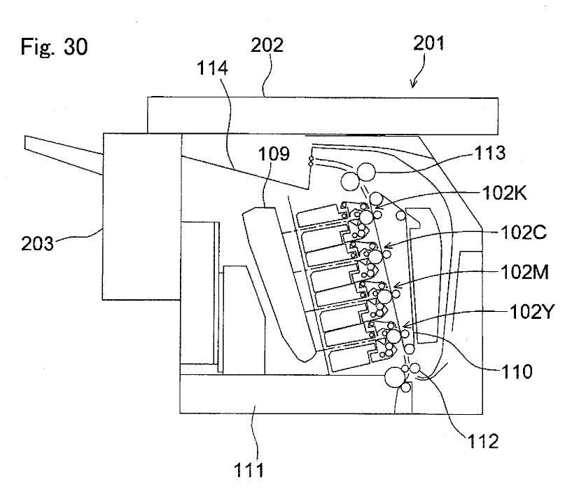

FIG. 30 shows an MFP 201, which is a more specific second image forming apparatus provided with the imaging cartridge according to the present invention. The MFP 201 is provided with a document reading device 202, and a sorter 203. The front surface of FIG. 30 is defined as the front face of the MFP 201. The sheet feeding unit 111 can be attached or detached from the front face. When the door at the front face is opened, the imaging cartridge 102 can be attached or detached in the second direction S2 (in the front-to-back direction of the figure).

### Second Embodiment of First Image Forming Apparatus

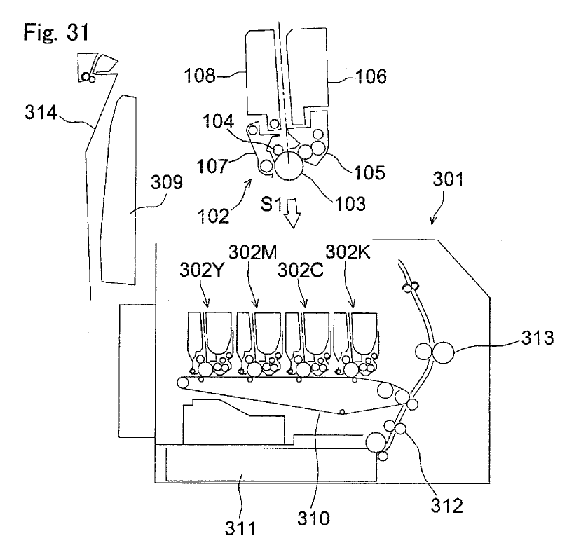

FIG. 31 shows a printer 301 that is a more specific first image forming apparatus provided with the imaging cartridge 302 according to the present invention. This printer 301 is a tandem-type color laser printer in which four imaging cartridges 302 (302Y, 302M, 302C, and 302K) are arranged in the horizontal direction. The structure of each of the imaging cartridges 302 is the same as that of the imaging cartridge shown in FIG. 29, and has the external structure (guide, handle, etc.) of the aforesaid imaging cartridges 1D. Further, the printer 301 includes an exposure device 309, a transfer belt 310, a sheet feeding unit 311, a timing roller 312, a fixing unit 313, and a sheet tray 314, like the printer 101 shown in FIG. 29, although the arrangement thereof is different.

The right side in FIG. 31 is the front face of the printer 301. This printer 301 is configured such that a sheet is supplied in the frontward direction from the sheet feeding unit 311, as viewed from the front face, conveyed in the vertical direction, and discharged in the rearward direction. The sheet feeding unit 311 can be attached or detached from the front face. When a door at the front face is opened, the exposure device 109 is separated from the imaging cartridge 302 with the door. Accordingly, the imaging cartridge 302 can be attached or detached in the first direction S1 (in the vertical direction in the figure).

### Second Embodiment of Second Image Forming Apparatus

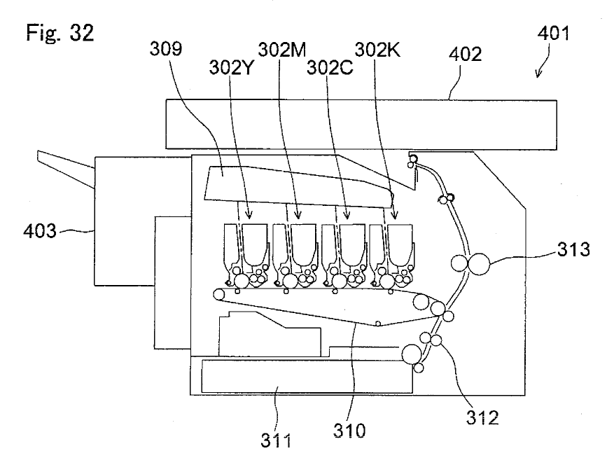

FIG. 32 shows an MFP 401 that is a more specific second image forming apparatus provided with the imaging unit 302 according to the present invention. The MFP 401 is provided with a document reading device 402, and a sorter 403. The front surface of FIG. 32 is defined as the front face of the MFP 401 The sheet feeding unit 311 can be attached or detached from the front face. When the door at the front face is opened, the imaging cartridge 302 can be attached or detached in the second direction S2 (in the front-to-back direction of the figure).

In the aforesaid embodiments, the imaging cartridges 102 and 302 may be configured as follows. Specifically, the photoreceptor 103, charging device 104, developing device 105, new toner box 106, cleaning device 107, and waste toner box 108 are optionally combined to form a cartridge, wherein each cartridge can be attached or detached.

Although the present invention has been fully described by way of the examples with reference to the accompanying drawing, it is to be noted that various changes and modifications will be apparent to those skilled in the art. Therefore, unless such changes and modifications otherwise depart from the spirit and scope of the present invention, they should be construed as being included therein.

1. An imaging cartridge that can be attached to or detached from a main body of an image forming apparatus, and that has components required for an image formation and a casing,
the cartridge being capable of being attached to or detached from a main body of a first image forming apparatus in a first direction, and being capable of being attached to or detached from a main body of a second image forming apparatus in a second direction that is different from the first direction by 90 degrees, and
the cartridge including a pair of handles that are gripped when the imaging cartridge is attached to or detached from the main body of the first image forming apparatus in the first direction, wherein
the handle of the pair of handles positioned at the far side when the imaging cartridge is attached to or detached from the main body of the second image forming apparatus in the second direction is comprised of a movable handle that moves in order not to hinder the attaching or detaching operation.

2. The imaging cartridge according to claim 1, wherein
the movable handle is mounted so as to be slidable on a guide rail formed to be parallel to the second direction of the casing, and wherein
when the imaging cartridge is attached to the main body of the second image forming apparatus in the second direction, the movable handle is brought into contact with an edge portion of an opening portion at the main body and remains at the edge portion, by which only the casing is inserted into the main body.

3. The imaging cartridge according to claim 2, wherein
the movable handle is brought into contact with the handle at the opposite side when the imaging cartridge is attached to the main body of the second image forming apparatus in the second direction.

4. The imaging cartridge according to claim 2, wherein
the movable handle has a pivot portion at its leading end, and wherein
when the imaging cartridge is attached to the main body of the second image forming apparatus in the second direction, the pivot portion of the movable handle abuts against the main body to be folded.

5. The imaging cartridge according to claim 2, wherein
the movable handle includes a positioning projection that is engaged with a hole formed on the second image forming apparatus, and an engagement hole with which a latch formed on the second image forming apparatus is engaged, when the imaging cartridge is attached to the main body of the second image forming apparatus in the second direction.

6. The imaging cartridge according to claim 1, wherein
the movable handle is pivotably mounted to the casing, and wherein
when the imaging cartridge is attached to the main body of the second image forming apparatus in the second direction, the movable handle pivots through the abutment against the main body of the second image forming apparatus, by which the movable handle is engaged with the guide rail mounted to the main body so as to slide thereon.

7. The imaging cartridge according to claim 1, wherein
the movable handle is slidably provided so as to project from the casing or so as to approach the casing, and wherein
when the imaging cartridge is attached to the main body of the first image forming apparatus in the first direction, the movable handle is pressed by the main body of the second image forming apparatus, and slides along a guide receiving portion formed on the main body to be inserted into the main body.

8. The imaging cartridge according to claim 1, wherein
the imaging cartridge is made by integrally forming at least two or more of a photosensitive unit including a photoreceptor and a charging device, a developing unit at least including a developing roller and a developing device, a toner hopper that accommodates new toner, and a waste toner bottle that accommodates waste toner.

9. An image forming apparatus provided with at least one of the imaging cartridges according to claim 1.
